(19) United States
(12) Patent Application Publication
(10) Pub. No.: US 2008/0068122 A1
(43) Pub. Date: Mar. 20, 2008

(54) Arrester Disconnector Assembly Minimizing Explosive Separation

(75) Inventors: Dennis W. Lenk, Medina, OH (US); James P. Price, Harlem, GA (US); John A. Krause, Medina, OH (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: HUBBELL INCORPORATED, Orange, CT (US)

(21) Appl. No.: 11/836,454

(22) Filed: Aug. 9, 2007

Related U.S. Application Data
(60) Provisional application No. 60/844,670, filed on Sep. 15, 2006.
(60) Provisional application No. 60/826,021, filed on Sep. 18, 2006.

(51) Int. Cl. H01H 39/00

(52) U.S. Cl. 337/30; 361/117

(57) ABSTRACT

A disconnector assembly for an arrester includes a housing having first and second opposite ends. A cavity is disposed within the housing. A first electrical terminal is disposed at the first end of the housing, and a second electrical terminal is disposed at the second end of the housing. A cartridge with an explosive charge disposed in the cavity between the first and second electrical terminals. The cartridge has a powder load greater than 0 grams and not greater than approximately 0.15 grams. The powder load is sufficient to separate said second electrical terminal from said first electrical terminal upon cartridge detonation while minimizing the intensity of the explosive separation upon unintended cartridge detonation.

### CROSS REFERENCE TO RELATED APPLICATIONS

This application claims the benefit under 35 U.S.C. § 119(e) of provisional patent application Ser. Nos. 60/844,670, filed Sep. 15, 2006 and 60/826,021, filed Sep. 18, 2006, both of which are hereby incorporated by reference in their entirety.

### FIELD OF THE INVENTION

The present invention relates to a disconnector assembly for an arrester that minimizes the explosive separation of the disconnector assembly. More particularly, the present invention relates to a disconnector assembly in which the detonation charge is reduced to minimize the explosive separation of the disconnector assembly. More particularly, the present invention relates to a disconnector assembly in which the build up of internal pressure in the disconnector assembly is reduced.

### BACKGROUND OF THE INVENTION

Lighting or surge arresters are typically connected to power lines to carry electrical surge currents to ground, thereby preventing damage to lines and equipment connected to the arresters. Arresters offer high resistance to normal voltage across power lines, but offer very low resistance to surge currents produced by sudden high voltage conditions caused by, for example, lighting strikes, switching surge currents or temporary overvoltages. After the surge, the voltage drops and the arrester normally returns to a high resistance state. However, upon arrester malfunction or failure, the high resistance state is not resumed, and the arrester continues to provide an electrical path from the power line to ground. Ultimately, the line will fail due to a short circuit condition, and the arrester will require replacement.

To avoid line lockout, disconnector assemblies are commonly used in conjunction with arresters to separate a malfunctioning arrester from the circuit and to provide a visual indication of arrester failure. Conventional disconnector assemblies have an explosive charge to destroy the circuit path and physically separate the electrical terminals. Examples of such disconnector assemblies are disclosed in U.S. Pat. No. 5,952,910 to Krause and U.S. Pat. Nos. 5,057,810 and 5,113,167 to Raudabaugh, as well as U.S. Pat. No. 5,434,550 to Putt, U.S. Pat. No. 4,471,402 to Cunningham, U.S. Pat. No. 4,609,902 to Lenk, U.S. Pat. No. 6,828,289 to Lenk et al., and U.S. Pat. No. 6,828,895 to Huo et al., the subject matter of each of which is hereby incorporated by reference.

Traditionally, polymer-housed distribution class arresters are assembled with a ground end insulating bracket that physically supports the arrester, as well as isolating the ground end of the arrester from the system ground in the event of arrester service failure. A ground lead connector, or isolator, connects the ground end of the isolator to the system neutral or ground wire.

In normal service conditions, the arrester grading current flows through the ground lead isolator. If the arrester fails, the arrester 60 Hz fault current flows through the failed arrester and through the ground lead disconnector, which causes the ground lead disconnector to operate. The disconnector disconnects from ground, thereby effectively isolating the failed arrester from ground. Separating the arrester from ground allows the utility to provide uninterrupted service to its customers. This also facilitates identifying the failed arrester so that it may be replaced with a new arrester.

Existing disconnectors typically have a grading component in parallel with a sparkgap. The grading component and sparkgap are located close to a detonating device, such as an unprimed cartridge. The grading component conducts the arrester grading current under normal service conditions. If arrester failure occurs, the arrester grading current increases from a few milliamperes to amperes or thousands of amperes, depending on the utility system grounding at the arrester location. This high current flow causes voltage to develop across the disconnector grading component. When voltage reaches a predetermined level, the parallel sparkgap sparks over, thereby causing heat build-up on the cartridge. The cartridge then detonates and separates the ground lead connection.

A problem with existing disconnectors is the explosive separation of the bottom end stud of the disconnector when the arrester is exposed to high temperatures, such as fire conditions, when not in service, such as during shipment to the customer. The exposure to high temperatures causes the internal blank cartridge to detonate, thereby explosively separating the bottom end stud. This explosive separation is potentially dangerous to anyone in the vicinity of the explosion. Therefore, a need exists for a disconnector assembly that minimizes the explosive separation of the disconnector assembly.

Furthermore, when the disconnector is exposed to high temperatures when not in service, there is a build-up of the internal pressure in the disconnector prior to the cartridge detonating. This pressure build-up further facilitates the explosive separation of the disconnector. Therefore, a need exists for a disconnector assembly that reduces the pressure build-up in the disconnector when exposed to high temperatures when not in service.

A need exists for an improved disconnector assembly for an arrester that minimizes the explosive separation of the disconnector assembly.

### SUMMARY OF THE INVENTION

Accordingly, it is a primary objective of the present invention to provide an improved disconnector assembly.

A further objective of the present invention is to provide a disconnector assembly for an arrester that minimizes the explosive separation of the disconnector assembly but is adequate for disconnection upon arrester failure.

A further objective of the present invention is to provide a disconnector assembly for an arrester that minimizes the explosive separation of the disconnector assembly when exposed to high temperatures when not in service.

A still further objective of the present invention is to provide a disconnector assembly for an arrester in which the build-up of internal pressure in the disconnector assembly is minimized when exposed to high temperatures when not in service.

The foregoing objects are basically attained by providing a disconnector assembly for an arrester. The disconnector assembly includes a housing having first and second opposite ends. A cavity is disposed within the housing. A first electrical terminal is disposed at the first end of the housing, and a second electrical terminal is disposed at the second end of the housing. A cartridge with an explosive charge disposed in the cavity between the first and second electrical terminals. The cartridge has a powder load greater than 0 grams and not greater than approximately 0.15 grams. The powder load is sufficient to separate said second electrical terminal from said first electrical terminal upon cartridge detonation while minimizing the intensity of the explosive separation upon unintended cartridge detonation.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings that form a part of the original disclosure, in which:

FIG. 1 is a side elevational view in partial cross section of a disconnector assembly according to a first exemplary embodiment of the present invention;

FIG. 2 is a top plan view in cross section of the disconnector assembly taken along line 2-2 of FIG. 1;

FIG. 3 is a side elevational view in partial cross section of a disconnector assembly according to a second exemplary embodiment of the present invention;

FIG. 4 is a side elevational view in partial cross section of a disconnector assembly according to a third exemplary embodiment of the present invention;

FIG. 5 is a side elevational view in partial cross section of a disconnector assembly according to a fourth exemplary embodiment of the present invention; and

FIG. 6 is a top plan view in cross section of the disconnector assembly taken along line 6-6 of FIG. 5.

Throughout the drawings, like reference numerals will be understood to refer to like parts, components and structures.

### DETAILED DESCRIPTION OF EXEMPLARY EMBODIMENTS

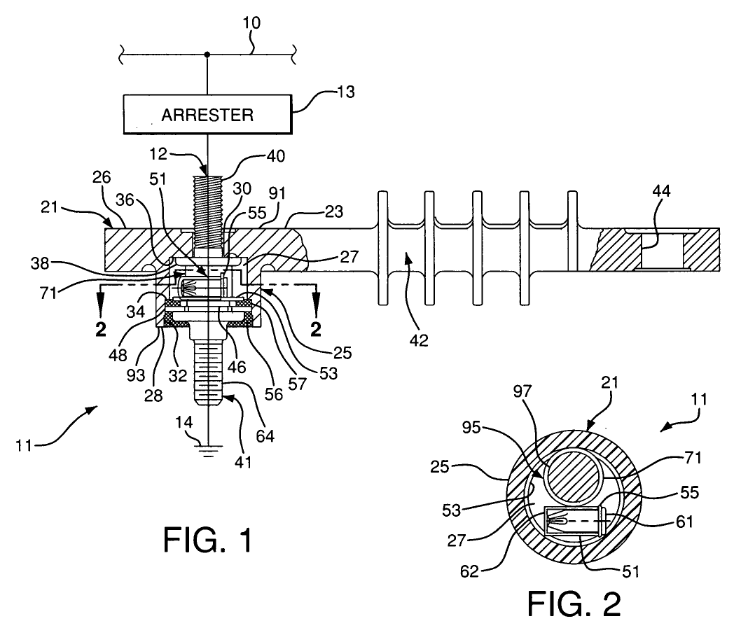

As shown in FIGS. 1-6, the present invention relates to a disconnector assembly 11 for an arrester 13 and connecting the arrester to ground 14. A non-conductive housing 21 has first and second opposite ends 91 and 93 separated by an internal chamber 27. A first electrical terminal 12 is connected at the first end 91. A second electrical terminal 41 is connected at the second end 93. A grading component 95 engages and extends between the first and second terminals 12 and 41 in the internal chamber 27. A cartridge 51 with an explosive charge is positioned in the internal chamber 27. A spring spacer 53 receives the cartridge 51. The spring spacer 53 is adjacent the second terminal 41 and spaced from the first terminal 12.

Referring initially to FIGS. I and 2, a disconnector assembly 11, according to an exemplary embodiment of the present invention, includes a first, upper electrical terminal 12 electrically connected to an arrester 13 that is connected to a power line 10, and a second, lower electrical terminal, or stud, 41 adapted to be electrically connected to ground. Arrester 13 is adapted to be electrically connected to a power line when in service. Terminals 12 and 41 are mechanically and electrically coupled to each other.

Arrester 13 is conventional, and thus, is not described in detail. The arrester may be formed according to U.S. Pat. No. 4,656,555 to Raudabaugh, the entire disclosure of which is hereby incorporated by reference.

The non-conductive housing 21 may include an integral disconnector assembly in which a conventional bracket includes the disconnector assembly 11. An example of such a bracket is disclosed in U.S. Pat. No. 4,609,902 to Lenk, the entire disclosure of which is hereby incorporated by reference. The bracket may have a plurality of weathersheds 42 and an opening 44 in the bracket adapted to secure the arrester 13 to a support. Following detonation of the cartridge 51, the remaining webbed portion of the non-conductive housing 21 continues to support the arrester 13. Alternatively, the non-conductive housing 21 may include a separable disconnector assembly, that is, the separable disconnector assembly is not physically part of the housing 21 and does not support the arrester 13. The separable disconnector assembly may include an insulating material, such as phenolic, epoxy or non-conductive plastic. Although the following description relates to an integral bracket-type disconnector assembly, the exemplary embodiments of the present invention apply to both the integral and separable disconnector assemblies.

Terminals 12 and 41 are mechanically connected to one another by a non-conductive housing 21, such as a bracket, as shown in FIGS. 1 and 3-5. The non-conductive housing 21 may be formed of any suitably strong insulating material, such as a non-conductive plastic. Preferably, the non-conductive housing 21 is made of a glass filled polyester material. As noted above, the non-conductive housing 21 has a base 23 and a wall 25 extending substantially perpendicularly from base 23 forming a boss section. The upper end of the cavity 27 is connected to bracket surface 26 by cylindrical upper bore 30. The lower end of cavity 27 is connected to surface 28 of wall 25 by a stepped lower chamber 32. The transverse diameter of the lower chamber 32 is preferably greater than the transverse diameter of internal cavity 27.

Between cavity 27 and lower chamber 32, the housing 21 has a radially extending lower annular shoulder 34. An upper shoulder 36 extends radially at the interface of the cavity 27 and the upper bore 30.

The upper electrical terminal 12 is of conventional construction, and has a head portion 38 located within the cavity 27 that abuts the upper shoulder 36. An externally threaded shank portion 40 of the terminal 12 extends from the head portion through the upper bore 30, such that the shank portion is at least partially exposed exteriorly of the housing 21 for coupling to the arrester 13. Thus, a first head portion surface engages the upper shoulder 36, while an opposing second head portion surface is exposed in the cavity 27.

A disconnector assembly 11 is disposed in the cavity 27. The disconnector assembly may include a grading component 95, a cartridge 51, and a spring spacer 53. The spring spacer 53 abuts the head portion 46 of the lower electrical terminal 41. Spring spacer 53 provides a biasing force to maintain electrical or physical contact of the disconnector assembly components within the cavity 27, and facilitates electrically connecting the lower terminal (stud) 41 to the upper terminal 12. Tab 55 extends upwardly from the spring spacer 53 into the cavity 27 and receives cartridge 51.

The grading component 95 is disposed in the cavity 27 and extends between the spring spacer 53 and the head portion 38 of the upper electrical terminal 12, thereby providing an electrical connection between the upper and lower terminals 12 and 41. Preferably, the grading component 95 is encased in an insulative sleeve or ceramic collar 71 to protect the grading component from contamination during a gap sparkover. The grading component 95 includes upper and lower terminals within the insulative sleeve 71. The upper terminal 97 is shown in FIG. 2. The terminals have conductive surfaces to provide an electrical connection from the upper terminal 12 through the grading component 95 to the lower terminal 41. The insulating sleeve 71 may have an RTV type material (a room temperature vulcanizing material, such as an elastomer sealant) oriented in the interface between the sleeve and the terminals to enhance the dielectric integrity of the interface. The grading component may be formed substantially similarly to the grading component disclosed in U.S. Pat. No. 6,828,895 to Huo et al. and U.S. Pat. No. 6,876,289 to Lenk et al. that include a high voltage capacitor, the entire disclosures of both patents being hereby incorporated by reference.

The cartridge 51 with an explosive charge is mounted in the cavity 27 adjacent the grading component 95. The cartridge 51 is elongated along a cartridge axis that is substantially perpendicular to the longitudinal axis of the terminals 12 and 41 and of the bracket cavity 27. The cartridge 51 receives the spring spacer tab 55 between its head 61 and body 62, as shown in FIG. 2, to secure the cartridge in the cavity 27 proximal the spring spacer 53.

The second terminal, or lower terminal, 41 is a conventional stud. The second terminal 41 has a head portion, or cap, 46 and a threaded shank portion 64. The terminal 41 is preferably maintained in position in the housing 21 by a suitable adhesive 56, such as an epoxy.

An adhesive 56 between the shoulder 48 of the head portion 46 and the wall 25 secures the second terminal within the housing 22. Any suitable adhesive may be used, but preferably the adhesive is a thick epoxy that has a fast curing time in air to avoid contaminating the disconnector assembly during the manufacturing process.

A gasket 57 is positioned between the upper surface of the shoulder 48 of the head portion 46 and the lower shoulder 34 of the cavity 27. The gasket further ensures adhesive 56 does not enter the cavity 27, thereby possibly damaging any of the components of the disconnector assembly 11.

As illustrated in FIGS. 1 and 2, a sparkgap is provided between the spring spacer tab 55, which is adjacent to the head 61 of the cartridge 51, and the exposed second surface of the head portion 38 of the upper terminal 12. The cartridge 51 detonates when the gap sparks over during arrester failure, thereby isolating the arrester 13 from ground by separating the upper and lower terminals 12 and 41. The disconnection of the arrester 13 from its ground connection prevents electrical lockout of the connected high voltage line.

However, certain conditions may cause the cartridge 51 to detonate prior to being placed in service, such as fires occurring during shipping. Fires create high temperatures that may cause unintended detonation of a cartridge 51. Such an explosion may be dangerous to anyone and anything in the vicinity of the explosion. One method of minimizing the explosive separation of the disconnector assembly 11 upon cartridge detonation is to reduce the charge load of the cartridge 51, as shown in FIG. 1. Conventional cartridges are unprimed 22 caliber blank cartridges having a powder load of 0.3 grams. An exemplary embodiment of the present invention includes a cartridge 51 having a reduced powder load of approximately 0.1017 grams. Preferably, the reduced powder load is not greater than 0.15 grams. Preferably, the reduced powder load is greater than 0 grams and not greater than approximately 0.15 grams. The reduced powder load still separates the upper and lower terminals 12 and 41 upon cartridge 51 detonation while in service (i.e., during arrester failure), while severely minimizing the explosive intensity of unintended cartridge detonation when not in service.

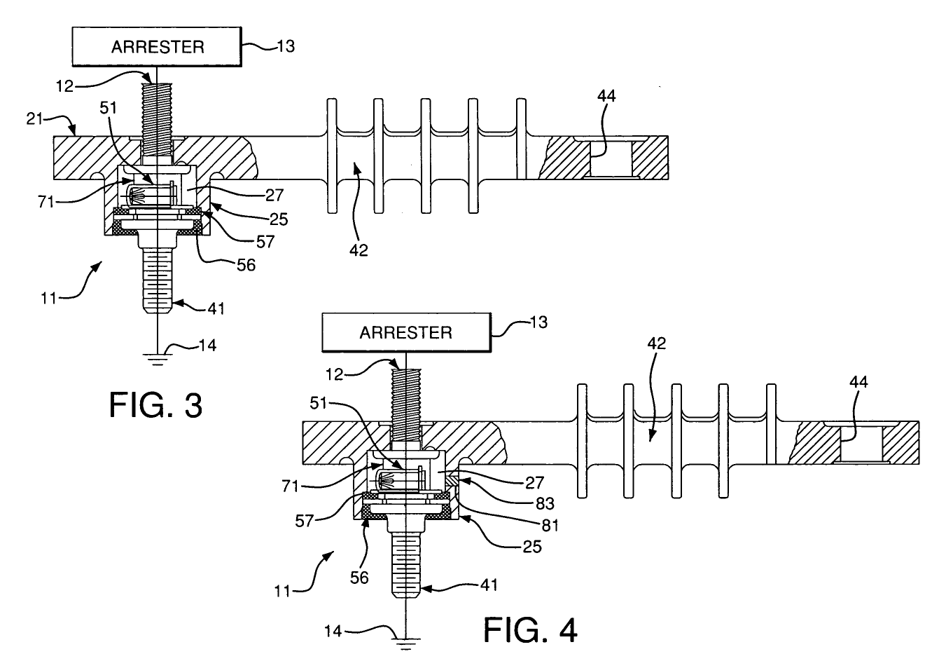

A second exemplary embodiment of the present invention relates to lowering the softening temperature of the adhesive 56 and/or the non-conductive housing 21, as shown in FIG. 3. Because the adhesive 56 securing the lower terminal 41 within the cavity 27 softens sooner upon exposure to high temperatures, significantly less pressure within the cavity 27 is required to separate the lower terminal upon unintended cartridge 51 detonation. Therefore, the explosive intensity of unintended cartridge detonation is minimized by reducing the softening temperature of the adhesive and/or the housing material, by selection of the adhesive having the appropriate softening temperature. Preferably, the softening temperature of the adhesive and/or the non-conductive housing is less than approximately 190 degrees Celsius.

A third exemplary embodiment of the present invention relates to providing a vent 81 in the wall 25 of the non-conductive housing 21, as shown in FIG. 4. The vent 81 allows for pressure reduction within the cavity 27 prior to cartridge 51 detonation. Thus, because the pressure within the cavity 27 is not allowed to build up, the explosive intensity of unintended cartridge detonation is minimized by venting the cavity 27. Additionally, a temperature sensitive material 83 may be disposed in the vent 81. The temperature sensitive material 83 melts upon exposure to high temperatures, such as during exposure to a fire, thereby limiting the magnitude of the pressure build-up within the cavity 27. Preferably, the temperature sensitive material melts at a temperature less than approximately 190 degrees Celsius. The vent 81 may be disposed through any member of the disconnector assembly 11 such that a first end of the vent opens to the cavity 27 and the second end of the vent is to the atmosphere.

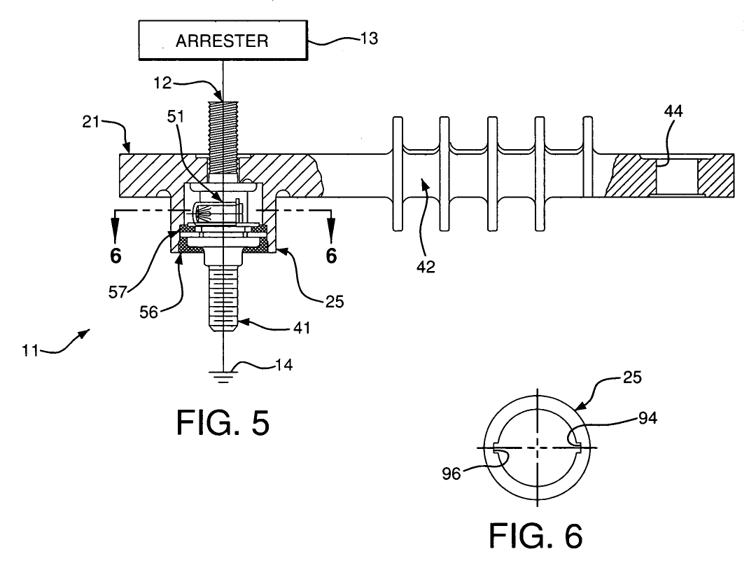

A fourth exemplary embodiment of the present invention relates providing a portion 94 of the wall 25 having a thinner thickness than the rest of the wall 25, as shown in FIGS. 5 and 6. The thin portion 94 causes the wall 25 to fracture at a lower internal pressure of the cavity than without the thin portion. This lower pressure fracturing reduces the internal pressure within the cavity 27. Thus, because the pressure within the cavity 27 is not allowed to build up, the explosive intensity of unintended cartridge detonation is minimized by providing a thin wall portion 94 of the wall 25. Any number of thin wall portions may be provided, such as first and second thin wall portions 94 and 96, as shown in FIG. 6.

Each of these exemplary embodiments may be individually used in disconnector assemblies to reduce the explosive separation upon unintended cartridge detonation. Alternatively, these exemplary embodiments may be used in any combination to reduce the explosive separation upon unintended cartridge detonation. Thus, the exemplary embodiments of the present invention provide a disconnector assembly 11 for reducing the explosive separation of the disconnector assembly upon unintended cartridge separation, while still functioning to separate the upper and lower terminals 12 and 41 as intended during in-service operation.

### Assembly and Disassembly

A fully assembled disconnector assembly 11 is shown in FIGS. 1-5. The upper electrical terminal 12 is inserted through bore 30 to connect the non-conductive bracket 21 to an arrester 13. The isolator assembly 11 is then simply dropped into cavity 27 over the terminal 12. The cavity 27 is then sealed by securing the gasket 57 and the lower terminal (stud) 41 to the wall 25 of the non-conductive housing 21 with an adhesive 56, such as epoxy. The disconnector assembly 11 is then completed by allowing the adhesive 56 to cure, thereby sealing the isolator assembly 11 in the cavity 27.

During normal non-fault operation of the arrester 13, little or no current passes through disconnector assembly 11 due to the high resistance of the arrester. When subjected to lighting or surge currents, the arrester discharges high pulse currents that travel through the arrester 13 and disconnector assembly 11. Within the disconnector assembly, the current arcs over between the spring spacer tab 55 of the cartridge 51 and the upper surface of the head portion 46 of the lower terminal 41 and to ground.

When the arrester is properly functioning, the gaps spark over for high current, short duration pulses which last less than 100 milliseconds for lightning and less than several milliseconds for switching currents. For such short sparkovers, insufficient energy is generated to activate or denote the cartridge. However, if the lightning arrester fails to withstand the surge duty and fails, system fault current flows through the series-connected disconnector assembly for a sufficiently extended period to activate the unprimed cartridge, causing an explosion that separates the terminals 12 and 41 mechanically from one another. The force of the exploded charge forces at least one of the terminals, usually lower terminal 41, from the housing 21. This action electrically disconnects the arrester 13 from the system, and provides a visual indication of the need for arrester replacement.

As discussed above, the exemplary embodiments of the present invention minimize the intensity of the explosive separation of the disconnector assembly upon unintended cartridge detonation, such as when a fire occurs during shipment, while still functioning to separate the upper and lower terminals 12 and 41 as intended during in-service operation.

While advantageous embodiments have been chosen to illustrate the invention, it will be understood by those skilled in the art that various changes and modifications may be made therein without departing from the scope of the invention as defined in the appended claims.

What is claimed is:

1. A disconnector assembly for an arrester, comprising:
a housing having first and second opposite ends;
a cavity formed in said housing;
a first electrical terminal disposed at said first end of said housing;
a second electrical terminal disposed at said second end of said housing; and
a cartridge with an explosive charge disposed in said cavity between said first and second electrical terminals, said cartridge having a powder load greater than 0 grams and not greater than approximately 0.15 grams, said powder load being sufficient to separate said second electrical terminal from said first electrical terminal upon cartridge detonation.

2. A disconnector assembly for an arrester according to claim 1, wherein
a spring spacer is disposed between said second electrical terminal and said cartridge.

3. A disconnector assembly for an arrester according to claim 2, wherein
a tab extends from said spring spacer to receive said cartridge.

4. A disconnector assembly for an arrester according to claim 1, wherein
said powder load is approximately 0.1017 grams.

5. A disconnector assembly for an arrester according to claim 2, wherein
an adhesive secures said second electrical terminal to said housing.

6. A disconnector assembly for an arrester according to claim 5, wherein
a gasket is disposed between said second terminal, said spring spacer and said housing to prevent said adhesive from entering said cavity.

7. A disconnector assembly for an arrester according to claim 5, wherein
said adhesive has a softening temperature of less than approximately 190 degrees Celsius to reduce the pressure required to separate said second electrical terminal from said first electrical terminal upon cartridge detonation.

8. A disconnector assembly for an arrester according to claim 1, wherein
a vent is disposed in said housing between said cavity and the atmosphere to reduce the pressure within the cavity such that the explosive intensity of said cartridge is lessened upon detonation.

9. A disconnector assembly for an arrester according to claim 8, wherein
a temperature sensitive material is disposed in said vent.

10. A disconnector assembly for an arrester according to claim 9, wherein
said temperature sensitive material melts at a temperature of less than approximately 190 degrees Celsius.

11. A disconnector assembly for an arrester according to claim 1, wherein
said housing is made of a material having a softening temperature of less than approximately 190 degrees Celsius.

12. A disconnector assembly for an arrester according to claim 1, wherein
a portion of a wall of said housing proximal said cartridge is thinner than a remaining portion of said wall to facilitate fracturing of said wall upon cartridge detonation.

13. A disconnector assembly for an arrester, comprising:
a non-conductive housing having first and second opposite ends;
a cavity formed in said housing;
a first electrical terminal disposed at said first end of said housing;
a second electrical terminal disposed at said second end of said housing;
a cartridge with an explosive charge disposed in said cavity, said cartridge having a powder load greater than 0 grams and not greater than approximately 0.15 grams, said powder load being sufficient to separate said second electrical terminal from said first electrical terminal upon cartridge detonation;
a spring spacer disposed between said second electrical terminal and said cartridge; and
a grading component disposed between said spring spacer and said first electrical terminal to provide an electrical connection between said first and second electrical terminals.

14. A disconnector assembly for an arrester according to claim 13, wherein
said powder load is approximately 0.1017 grams.

15. A disconnector assembly for an arrester according to claim 13, wherein
an adhesive secures said second electrical terminal to said housing.

16. A disconnector assembly for an arrester according to claim 15, wherein
a gasket is disposed between said second terminal, said spring spacer and said housing to prevent said adhesive from entering said cavity.

17. A disconnector assembly for an arrester according to claim 15, wherein
said adhesive has a softening temperature of less than approximately 190 degrees Celsius to reduce the pressure required to separate said second electrical terminal from said first electrical terminal upon cartridge detonation.

18. A disconnector assembly for an arrester according to claim 13, wherein
a vent is disposed in said housing between said cavity and the atmosphere to reduce the pressure within the cavity such that the explosive intensity of said cartridge is lessened upon detonation.

19. A disconnector assembly for an arrester according to claim 13, wherein
a temperature sensitive material is disposed in said vent.

20. A disconnector assembly for an arrester according to claim 19, wherein
said temperature sensitive material melts at a temperature of less than approximately 190 degrees Celsius

21. A disconnector assembly for an arrester according to claim 13, wherein
a portion of a wall of said housing proximal said cartridge is thinner than a remaining portion of said wall to facilitate fracturing of said wall upon cartridge detonation.

22. A disconnector assembly for an arrester according to claim 13, wherein
said grading component is disposed in an insulative sleeve.

23. A disconnector assembly for an arrester according to claim 13, wherein
said housing is made of a material having a softening temperature of less than approximately 190 degrees Celsius.
